(19) United States
(12) Patent Application Publication
(10) Pub. No.: US 2004/0111789 A1
(43) Pub. Date: Jun. 17, 2004

(54) Body protector

(75) Inventor: Motohiro Niki, Tokyo-To (JP)

Correspondence Address: Ladas & Parry, 26 West 61st Street, New York, NY, 10023, US

(73) Assignees: MOTOHIRO NIKI; ATSUSHI KIDACHI; MIEKO NIKI; ETUKO NIKI; MISAKO KIDACHI

(21) Appl. No.: 10/321,238

(22) Filed: Dec. 17, 2002

(51) Int. Cl. A62B 17/00; G21F 3/02; F41H 1/00

(52) U.S. Cl. 2/455

(57) ABSTRACT

A body protector comprises a plastic sheet provided with numerous air cells on one of its surfaces, and plane fastening members attached at least to the opposite end edge parts, respectively, of the plastic sheet. The plastic sheet is wound around a desired part of a human body in a tubular shape, and the plane fastening members are joined together to hold the plastic sheet on the desired part of the human body. A gap is formed between the opposite end edges of the plastic sheet when the body protector is put on the desired part.

### BACKGROUND OF THE INVENTION

1. Field of the Invention

The present invention relates to a simple body protector to be wound around a desired part of a human body, such as the elbow, the knee, the chest or the abdomen for protection.

2. Description of the Related Art

Body protectors for protecting the elbow and the knee of a human body are marketed and used to protect bodies of people playing sports from danger that may be experienced during playing sports and old people fallen to the ground. Conventional body protectors are formed from considerably thick fabrics or leather and heavy, cannot be easily put on human bodies, are expensive, and cannot be easily thrown away when they fell into disuse. Thus, conventional body protectors could not have been readily used for protecting sport players from danger that may be experienced during playing sports and for protecting old people fallen to the ground.

### SUMMARY OF THE INVENTION

The present invention has been made in view of those problems and it is therefore an object of the present invention to provide an inexpensive, lightweight, easy-to-wear, readily usable, disposable, body protector.

The present invention provides a body protector comprising: a plastic sheet provided with numerous air cells on one of its surfaces; and plane fastening members attached at least to opposite end edge parts, respectively, of the plastic sheet; wherein the plastic sheet is wound around a desired part of a human body in a tubular shape, and the plane fastening members are joined together to hold the plastic sheet on the desired part of the human body.

In the body protector according to the present invention, the plastic sheet may be trapezoidal, and the plane fastening members may be attached to the unparallel opposite end edge parts of the plastic sheet.

In the body protector according to the present invention, the plane fastening member attached to one of the unparallel end edge parts may be extended along the corresponding end edge, the plane fastening members attached to the other end edge part may be extended parallel with opposite side edges of the plastic sheet and may be spaced apart from each other with respect to a direction along the width of the plastic sheet, and the plastic sheet may be formed in a size such that gap is formed between the opposite end edges of the plastic sheet to expose a part of the human body therethrough when the plastic sheet is wound around the desired part of the human body and the fastening members are joined together.

In the body protector according to the present invention, the plastic sheet may be consists of a single plastic sheet provided with numerous air cells arranged on one of its surfaces.

In the body protector according to the present invention, the plastic sheet may be a multilayer plastic sheet formed by superposing a plurality of component plastic sheets each provided with numerous air cells on one of its surfaces.

In the body protector according to the present invention, the plastic sheet may be provided with thermocompression-bonded parts formed by bonding parts of the opposite surfaces of the plastic sheet by thermocompression bonding.

In the body protector according to the present invention, the plastic sheet may be provided with stitched parts formed by joining together parts of the opposite surfaces of the plastic sheet by stitching.

In the body protector according to the present invention, the opposite end edges of the plastic sheet may be formed in a shape conforming to the shape of a desired bendable part of a human body around which the body protector is to be wound.

### BRIEF DESCRIPTION OF THE DRAWINGS

The above and other objects, features and advantages of the present invention will become more apparent from the following description taken in connection with the accompanying drawings, in which:

FIG. 1 is a plan view of a body protector in a first embodiment according to the present invention in an unfolded state;

FIG. 2 is a sectional view of a plastic sheet provided with numerous air cells on one of its surfaces and forming a principal part of the body protector shown in FIG. 1;

FIG. 3 is a perspective view of the body protector shown in FIG. 1 wound in a tubular shape for use;

FIG. 4 is a plan view of a body protector in a second embodiment according to the present invention in an unfolded state;

FIG. 5 is a perspective view of the body protector shown in FIG. 4 as used for protecting the knee;

FIG. 6 is plan view of a body protector in a third embodiment according to the present invention in an unfolded state;

FIG. 7 is a sectional view taken on line A-A in FIG. 6; and

FIG. 8 is a perspective view of the body protector as used for protecting the knee.

### DESCRIPTION OF THE PREFERRED EMBODIMENTS

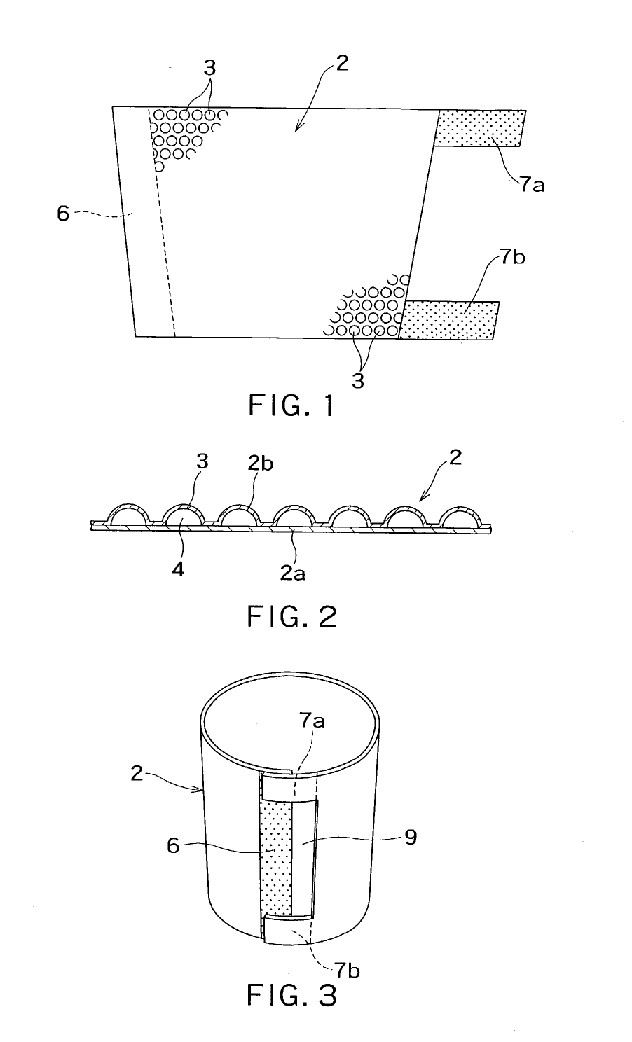

Referring to FIG. 1 showing a body protector in a first embodiment, the body protector has, as a principal component, a trapezoidal plastic sheet 2 provided with numerous air cells 4 on one of its surfaces. The plastic sheet 2 is a generally known one. As shown in FIG. 2, the plastic sheet 2 is formed by bonding together a first sheet 2a of a polyethylene resin or the like, and a second sheet 2b having numerous small domed bulges 3. The first sheet 2a and the domed bulges 3 form the air cells 4. A first plane fastening member 6 is attached to one of the opposite unparallel end edge parts of the plastic sheet 2 so as to extend along the corresponding end edge, and second plane fastening members 7a and 7b are attached to the opposite ends of the other end edge part so as to extend outward from the corresponding end edge. When the first plane fastening member 6 is a hook tape with minute hooks, the second plane fastening members 7a and 7b are loop tapes with minute loops. When the first plane fastening member 6 is a loop tape with minute loops, the second plane fastening members 7a and 7b are hook tapes with minute hooks. The body protector may be provided with more plane fastening members in addition to the plane fastening members 6, 7a and 7b. The length of working parts projecting from the end edge of the plastic sheet 2 of the second plane fastening members 7a and 7b is greater than the width of the first plane fastening member 6. Three or more second plane fastening members may be attached to the end edge part to which the plane fastening members 7a and 7b are attached.

The body protector is wound around a desired part of a human body, such as the knee, the elbow, the abdominal region, the chest region or such, in a tubular shape as shown in FIG. 3. The width and the length of the plastic sheet 2, the width of the first plane fastening member 6, and the length of the working parts of the second plane fastening members 7a and 7b are dependent on the desired part around which the body protector is wound. For example, those dimensions of the components of body protectors for protecting the abdominal region or the chest region are large. Those dimensions of body protectors for protecting the knee or the elbow are small. The first plane fastening member 6 is attached to one of the surfaces of the plastic sheet 2, and the second plane fastening members 7a and 7b are attached to the other surface of the same. Although it is desirable that the plastic sheet 2 has flat parts and the plane fastening members 6, 7a and 7b are attached to those flat parts of the plastic sheet 2, the plane fastening members 6, 7a and 7b may be attached to the plastic sheet 2 by any suitable attaching means.

The plastic sheet 2 of the body protector is wound around a desired part of a human body in a tubular shape as shown in FIG. 3. Although the plastic sheet 2 may be wound around the desired part of the human body either with its surface provided with the domed bulges 3 facing outside or facing the desired part, the shock-absorbing ability of the body protector may be exercised more effectively when the plastic sheet 2 is wound around the desired part with its surface provided with the domed bulges 3 facing the desired part. However, such a manner of putting the body protector on the desired part may possibly reduce the reliability of the body protector remaining in place on the desired part.

When the body protector shown in FIG. 1 having an appropriate size is wound around the desired part in a tubular shape as shown in FIG. 3, only free end parts of the second plane fastening members 7a and 7b engage with the first plane fastening member 6, and a gap 9 of a width corresponding to base end parts of the second plane fastening members 7a and 7b is formed between the opposite end edges of the plastic sheet 2. A part of the desired part is exposed through the gap 9, which prevents the desired part protected by the body protector from becoming ill moistened. The width of the gap 9 is adjustable by properly determining the length of the second plane fastening members 7a and 7b.

When the body protector is put on the desired part with its surface provided with the domed bulges 3 in contact with the desired part and its smooth, flat surface facing outside, the domed bulges 3 ensure the close contact of the plastic sheet 2 with the desired part and prevent the body protector from slipping out of place, and the smooth, flat surface reduces friction between the plastic sheet 2 and the clothes. When the plastic sheet 2 of the body protector is long, the plastic sheet 2 can be wound in a double layer, which enhances the cushioning effect of the body protector. The length and the width of the plastic sheet 2 are dependent on the size of the desired part of the human body.

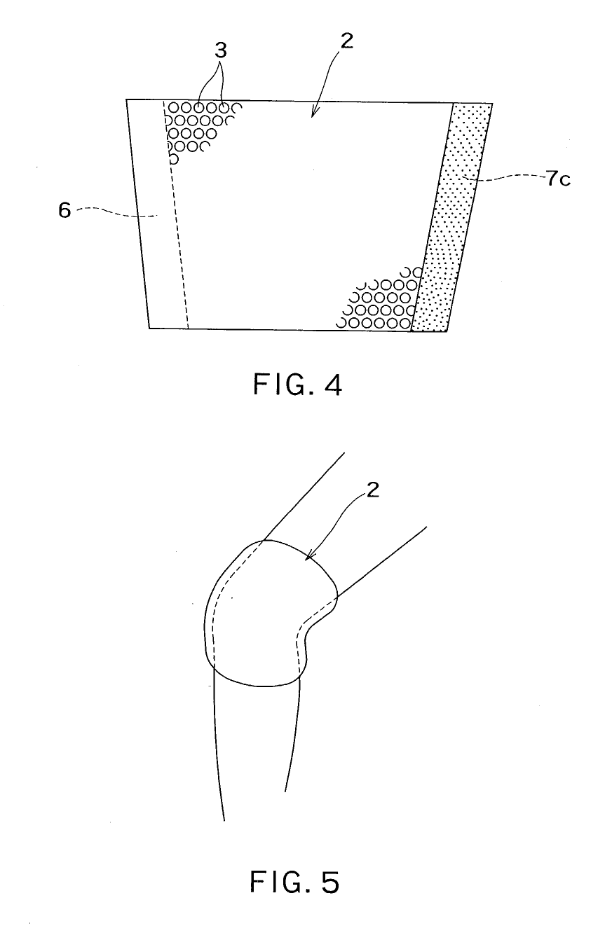

Referring to FIG. 4 showing a body protector in a second embodiment according to the present invention, the body protector has a trapezoidal plastic sheet 2, and a first plane fastening member 6 attached to one of the unparallel end edge parts of the plastic sheet 2, and a second plane fastening member 7c attached to the other end edge part of the same. The construction of the plastic sheet 2 is the same as that of the plastic sheet 2 of the body protector in the first embodiment. FIG. 5 shows the body protector in the second embodiment as wound around the knee, i.e., a desired part of a human body. As shown in FIG. 5, any gap like the gap 9 shown in FIG. 3 is not formed between the opposite end edges of the plastic sheet 2 and hence the knee may possibly be ill moistened, which, however, will not cause any trouble when the body protector is used for a short time.

Although the plastic sheets 2 of the body protectors in the first and the second embodiment are trapezoidal, the plastic sheets 2 may be of any suitable shape, such as a rectangular shape or a round shape, depending on the desired part around which the body protector is wound and purposes of use. If the length of the plastic sheet 2 is not long enough to wind the body protector around a desired part of a human body, two or more trapezoidal plastic sheets 2 may be connected by using the plane fastening members to obtain a single, long plastic sheet. In such a case, the trapezoidal plastic sheets 2 are inverted alternately.

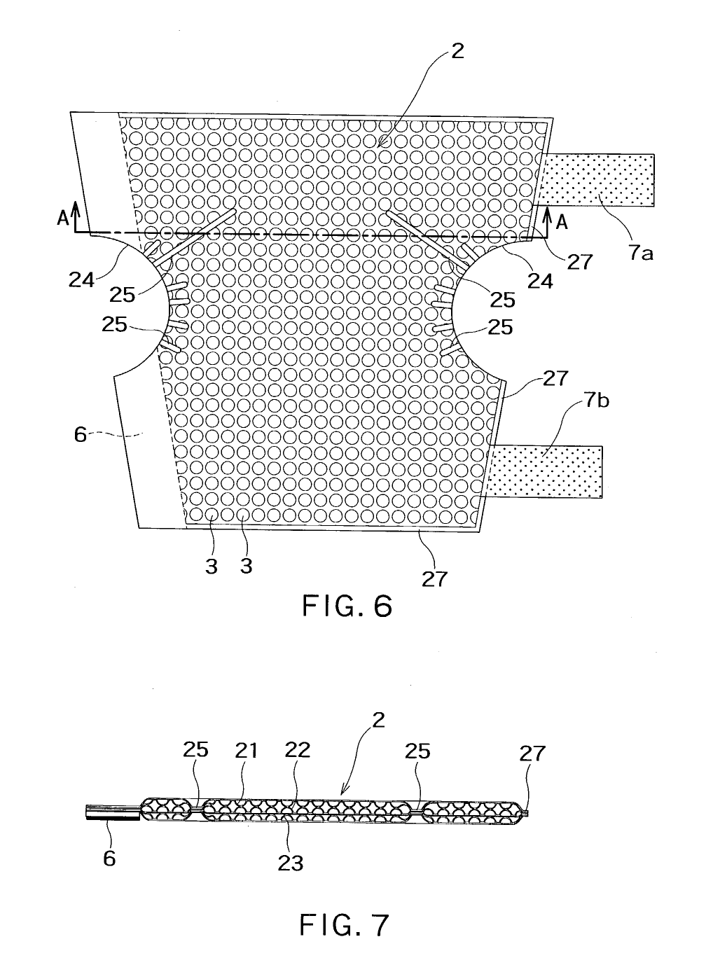

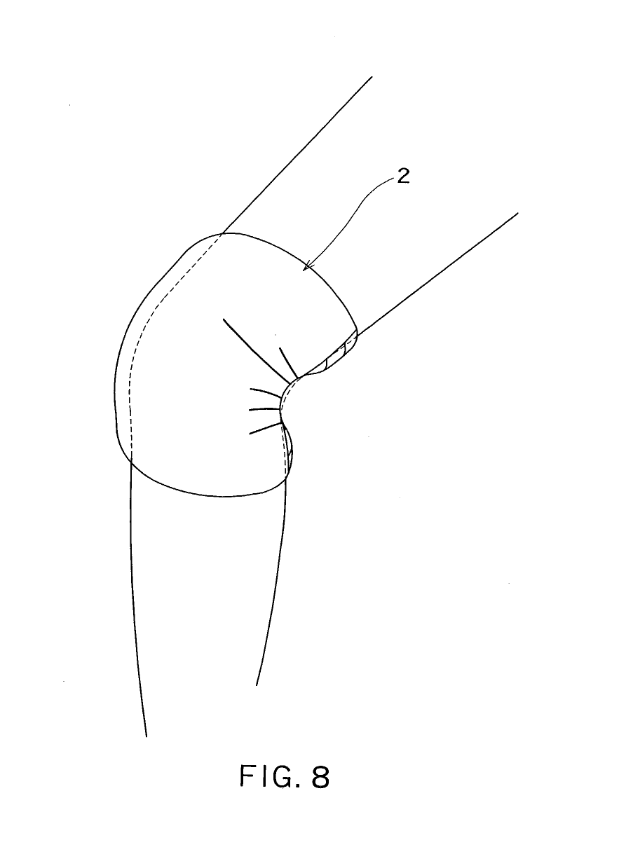

A body protector in a third embodiment according to the present invention will be described with reference to FIGS. 6 to 8. FIG. 6 is a plan view of the body protector in the third embodiment in an unfolded state, FIG. 7 is a sectional view taken on line A-A in FIG. 6, and FIG. 8 is a perspective view of the body protector as used for protecting the knee.

The body protector in the third embodiment has a multilayer plastic sheet 2 formed by superposing three component plastic sheets 21, 22 and 23. The component plastic sheets 21, 22 and 23 are similar in construction to the plastic sheet 2 shown in FIG. 2. Semicircular recesses 24 are formed in the opposite end edges of the multilayer plastic sheet 2. Radial thermocompression-bonded parts 25 are formed by bonding parts of the opposite surfaces of the plastic sheet 2 by thermocompression bonding so as to extend radially from the edges defining the semicircular recesses 24. Stitched parts may be formed in the multilayer plastic sheet 2 instead of the thermocompression-bonded parts 25. Thermocompression-bonded parts 27 are formed along the edges of the multilayer plastic sheet 2.

The recesses 24 has a shape conforming to the shape of a desired bendable part of a human body and insures the smooth bending motion of the desired bendable part when the body protector is wound around the desired bendable part. The recesses 24 enable the body protector to adapt itself to a desired bendable part having a complicated shape. The edges of the multilayer plastic sheet 2 can be simply finished by forming the thermocompression-bonded parts 27. The three superposed component plastic sheets 21, 22 and 23 can be simply bonded together so as to be immovable relative to each other by the thermocompression-bonded parts 25 and 27. Since the three superposed component plastic sheets 21, 22 and 23 are bonded together only by the thermocompression-bonded parts 25 and 27, other parts of the component plastic sheets 21, 22 and 23 are separated from each other. Therefore, even if one of the three component plastic sheets 21, 22 and 23 should be broken, the rest of the component plastic sheets are not broken and the body protector can be used.

The number of the component plastic sheets is not limited to three; the plastic sheet 2 of the body protector may be formed by superposing any suitable number of component plastic sheets depending on a desired part of a human body around which the plastic sheet 2 is to be wound. For example, if the body protector is used to protect a desired part of a human body covered with clothes and only a narrow space around the desired part is available for placing the body protector, the plastic sheet 2 formed by superposing a small number of component plastic sheets is used. If the body protector is to be used for protecting a desired part of a human body around which a high external force is expected to be wound, a plastic sheet 2 formed by superposing a large number of component plastic sheets is used.

As apparent from the foregoing description, the body protector of the present invention has, as a principal component, the inexpensive plastic sheet provided on its one surface with the numerous air cells 4 formed by the domed bulges 3, and the body protector can be simply fabricated by attaching the plane fastening members to the plastic sheet. Thus, the body protector is lightweight, easy to use, simple to put on a desired part of a human body, disposable and capable of being put on a desired part covered with clothes. Since the body protector is lightweight and highly flexible, even aged people are able to bend and stretch their legs and arms when the body protectors of the present invention are wound around their arms and the legs. The body protector can be readily put on and taken off a desired part to be protected from danger of a human body and can be readily moved from one desired part to another. The body protector can be wound in a double layer around a desired part which is expected to be exposed to high danger.

The body protector having the trapezoidal plastic sheet can be snugly wound around a desired, tapered part of a human body, such as the knee or the elbow. The plane fastening members attached to the unparallel opposite end edge parts of the plastic sheet facilitate fastening the body protector to a desired part of a human body.

When the body protector having the plastic sheet provided with the first plane fastening member attached to one of the opposite unparallel end edge parts thereof so as to extend along the corresponding end edge, and the second plane fastening members attached to the other end edge part so as to extend outward from the corresponding end edge is wound around a desired part of a human body in a tubular shape, the gap is formed between the unparallel end edges of the plastic sheet and a part of the human body is exposed through the gap. The body protector can be put on a desired part of a human body with the gap located at an optional position in an optional direction.

When the plastic sheet is formed of a plastic material capable of being incinerated for disposal and of avoiding environmental contamination, the body protector can be readily disposed of.

When the body protector is put on a desired part of a human body with its surface provided with the air cells in contact with the desired part and its smooth, flat surface facing outside, the domed bulges ensure the close contact of the plastic sheet with the desired part and prevent the body protector from slipping out of place, and the smooth, flat surface reduces friction between the plastic sheet and the clothes, which facilitate putting clothes on and taking the same off.

When the plastic sheet of the body protector is long, the plastic sheet can be wound in a double layer, which enhances the cushioning effect of the body protector and provides the effect of taping.

Although the invention has been described in its preferred embodiments with a certain degree of particularity, obviously many changes and variations are possible therein. It is therefore to be under stood that the present invention may be practiced otherwise than as specifically described herein without departing from the scope and spirit thereof.

What is claimed is:

1. A body protector comprising:
a plastic sheet provided with numerous air cells on one of its surfaces; and
plane fastening members attached at least to opposite end edge parts, respectively, of the plastic sheet;
wherein the plastic sheet is wound around a desired part of a human body in a tubular shape, and the plane fastening members are joined together to hold the plastic sheet on the desired part of the human body.

2. The body protector according to claim 1, wherein the plastic sheet is trapezoidal.

3. The body protector according to claim 2, wherein the plane fastening members are attached to the unparallel opposite end edge parts of the plastic sheet.

4. The body protector according to claim 3, wherein the plane fastening member attached to one of the unparallel end edge parts is extended along the corresponding end edge, the plane fastening members attached to the other end edge part are extended parallel with opposite side edges of the plastic sheet and are spaced apart from each other with respect to a direction along the width of the plastic sheet, and the plastic sheet is formed in a size such that gap is formed between the opposite end edges of the plastic sheet to expose a part of the human body therethrough when the plastic sheet is wound around the desired part of the human body and the fastening members are joined together.

5. The body protector according to claim 1, wherein the plastic sheet consists of a single plastic sheet provided with numerous air cells arranged on one of its surfaces.

6. The body protector according to claim 1, wherein the plastic sheet is a multilayer plastic sheet formed by superposing a plurality of component plastic sheets each provided with numerous air cells on one of its surfaces.

7. The body protector according to claim 1, wherein the plastic sheet is provided with thermocompression-bonded parts formed by bonding parts of the opposite surfaces of the plastic sheet by thermocompression bonding.

8. The body protector according to claim 1, wherein the plastic sheet is provided with stitched parts formed by joining together parts of the opposite surfaces of the plastic sheet by stitching.

9. The body protector according to claim 1, wherein the opposite end edges of the plastic sheet are formed in a shape conforming to a shape of a desired bendable part of a human body around which the body protector is to be wound.
